(19) United States
(12) Patent Application Publication
(10) Pub. No.: US 2023/0261187 A1
(43) Pub. Date: Aug. 17, 2023

(54) INTERMEDIATE FOR PREPARATION OF POROUS SILICON OXYCARBIDE, PREPARATION METHOD THEREFOR, AND LITHIUM SECONDARY BATTERY COMPRISING POROUS SILICON OXYCARBIDE PREPARED THEREFROM AS ANODE ACTIVE MATERIAL

(71) Applicant: IUCF-HYU (INDUSTRY-UNIVERSITY COOPERATION FOUNDATION HANYANG UNIVERSITY), Seoul (KR)

(72) Inventors: Hee Joon AHN, Seoul (KR); Se Hun LEE, Seoul (KR); Chang Young PARK, Seoul (KR); Kwang Hyun DO, Busan (KR)

(73) Assignee: IUCF-HYU (INDUSTRY-UNIVERSITY COOPERATION FOUNDATION HANYANG UNIVERSITY), Seoul (KR)

(21) Appl. No.: 18/013,528

(22) PCT Filed: Jun. 18, 2021
(86) PCT No.: PCT/KR2021/007645

§ 371 Date: Dec. 28, 2022

(30) Foreign Application Priority Data
Jun. 29, 2020 (KR) 10-2020-0078985

(51) Int. Cl. H01M 4/58; C08G 77/52; C08G 77/44; C01B 32/907; H01M 10/0525; H01M 4/38; H01M 4/134; H01M 4/133

(52) U.S. Cl. CPC H01M 4/5825; C08G 77/52; C08G 77/44; C01B 32/907; H01M 10/0525; H01M 4/386; H01M 4/134; H01M 4/133; C01P 2006/12; C01P 2006/14; C01P 2006/40; C01P 2004/04; C01P 2002/82; C01P 2002/88; H01M 2004/027

(57) ABSTRACT

The present invention relates to an intermediate for preparing porous silicon oxycarbide, a method of preparing the same, and a lithium secondary battery including porous silicon oxycarbide prepared from the same as a negative electrode active material. According to the present invention, since an intermediate prepared by adding a polyhedral oligomeric silsesquioxane (POSS) to a reaction mixture for preparing silicon oxycarbide, which is composed of a polysiloxane polymer and an aromatic compound, is pyrolyzed to prepare porous silicon oxycarbide (SiOC), although the content of a free carbon region is lower compared to conventional silicon oxycarbide, the cage structure of the POSS is maintained in the pyrolysis to form many pores uniformly distributed in the SiOC matrix, and thus rapid diffusion of electrolyte ions is possible, and because the contents of SiO₃C and SiO₂C₂ in the SiOC matrix are increased, a reversible capacity in the Si—O—C phase can be enhanced.

### TECHNICAL FIELD

The present invention relates to a lithium secondary battery, and more specifically, to a negative electrode active material for a lithium ion secondary battery.

### BACKGROUND ART

As negative electrode active materials of conventional lithium ion secondary batteries, silicon (4200 mAh/g) having a high theoretical capacity has been considered as a next-generation material that will replace a graphite (372 mAh/g) negative electrode material.

However, since silicon is able to accommodate up to 4.4 lithium atoms per atom (4.4Li+Si↔Li4.4Si), a large volume change (300-400%) occurs during lithiation and delithiation processes. As the volumetric expansion and contraction processes are repeated, mechanical fracture inside an electrode, contact loss between particles, and formation of a thick solid electrolyte interphase (SEI) between a negative electrode and an electrolyte are caused, and thus there is a problem in that lithium does not approach an electrode, resulting in a degradation behavior. Due to these negative effects, the charge/discharge stability of a secondary battery including silicon rapidly decreases.

### DISCLOSURE

### Technical Problem

The present invention is directed to providing a novel intermediate for preparing porous silicon oxycarbide.

The present invention is also directed to providing a method of preparing the intermediate.

The present invention is also directed to providing porous silicon oxycarbide prepared from the intermediate.

The present invention is also directed to providing a method of preparing porous silicon oxycarbide using the intermediate.

The present invention is also directed to providing porous silicon oxycarbide prepared by the preparation method.

The present invention is also directed to providing a lithium secondary battery which includes: a negative electrode including the porous silicon oxycarbide as a negative electrode active material; and a positive electrode.

### Technical Solution

One aspect of the present invention provides an intermediate for preparing porous silicon oxycarbide. The intermediate has a three-dimensional network structure and includes: linear polysiloxane polymer main chains; a plurality of polyhedral oligomeric silsesquioxane (POSS) moieties disposed between the linear polysiloxane polymer main chains; and a bond represented by the following Chemical Formula 1, which is formed between the linear polysiloxane polymer and the POSS moiety.

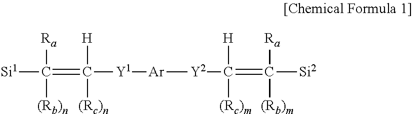

(In Chemical Formula 1,

Si¹ represents a linear polysiloxane polymer,

Si² represents a POSS moiety,

Rₐ, R_{b}, and R_{c} each independently represent a hydrogen atom or a C₁ to C₂₀ linear or branched alkyl,

Y¹ and Y² each independently represent a bond, —O—, —S—, or a C₁ to C₂₀ alkylene,

n and m are each independently 0 or 1,

when n=1 or m=1, bonds ( [symbol] ) between CRₐR_{b} and CR_{c}H are each independently a single bond,

when n=0 or m=0, bonds ( [symbol] ) between CRₐR_{b} and CR_{c}H are each independently a double bond, and

[symbol]

Ar represents a C₃ to C₂₀ arylene or heteroarylene, wherein the heteroarylene includes at least one of N, O, and S in the ring.)

The intermediate may be in the form of an aerogel.

The POSS moiety may be any one or a combination of the following compounds (1) to (6).

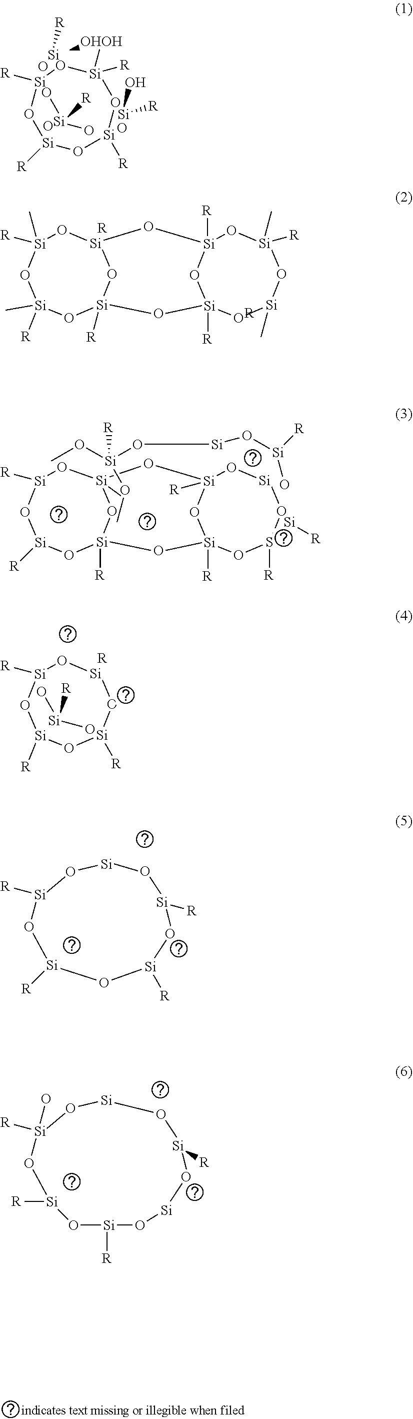

(In individual compounds (1) to (6), at least two Rs each independently represent —OSi²R^{A}R^{B}—*, wherein R^{A} and R^{B} represent any one of a hydrogen atom, a halogen atom, a hydroxy, and a C₁ to C₂₀ linear or branched alkyl, alkene, alkyne, or alkoxy, and

the remaining Rs each independently represent any one of a hydrogen atom, a halogen atom, a hydroxy, a C₁ to C₂₀ linear or branched alkyl, alkene, alkyne, or alkoxy, a C₅ to C₂₀ aryl, and —OSir¹r²r³, wherein r¹, r², and r³ each independently represent any one of a hydrogen atom, a halogen atom, a hydroxy, and a C₁ to C₂₀ linear or branched alkyl, alkene, alkyne, or alkoxy.)

The POSS moiety may have a cage structure.

The POSS moiety may be included in an amount of less than 3 parts by weight based on 100 parts by weight of the intermediate.

Another aspect of the present invention provides a method of preparing an intermediate for preparing porous silicon oxycarbide. The method of preparing an intermediate includes hydrosilylating a linear polysiloxane polymer, a polyhedral oligomeric silsesquioxane (POSS), and an aromatic compound, in which two or more functional groups including a vinyl group or an acetylene group at a terminal thereof are substituted, to form an organosilicon bond between the linear polysiloxane polymer and the aromatic compound and between the POSS and the aromatic compound.

The linear polysiloxane polymer may have a repeat unit represented by the following Chemical Formula 2.

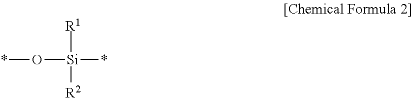

(In Chemical Formula 2,

R¹ and R² each independently represent a hydrogen atom or a C₁ to C₂₀ linear or branched alkyl, and

at least one of R¹ and R² represents a hydrogen atom.)

The POSS may be represented by the following Chemical Formula 3.

(R′—SiO_{1.5})ₙ [Chemical Formula 3]

(In Chemical Formula 3,

n is 8 to 16, at least two of the 8 to 16 R′s represent —OSi²HR^{A}R^{B} involved in the hydrosilylation, wherein R^{A} and R^{B} represent any one of a hydrogen atom, a halogen atom, a hydroxy, and a C₁ to C₂₀ linear or branched alkyl, alkene, alkyne, or alkoxy, and

the remaining Rs each independently represent any one of a hydrogen atom, a halogen atom, a hydroxy, a C₁ to C₂₀ linear or branched alkyl, alkene, alkyne, or alkoxy, a C₅ to C₂₀ aryl, and —OSir¹r²r³, wherein r¹, r², and r³ each independently represent any one of a hydrogen atom, a halogen atom, a hydroxy, and a C₁ to C₂₀ linear or branched alkyl, alkene, alkyne, or alkoxy.)

The organosilicon bond between the linear polysiloxane polymer and the aromatic compound and between the POSS and the aromatic compound may be represented by the following Chemical Formula 1.

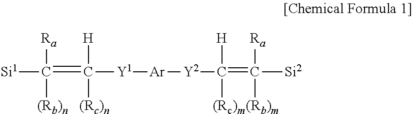

(In Chemical Formula 1,

Si¹ represents a linear polysiloxane polymer,

Si² represents a POSS,

Rₐ, R_{b}, and R_{c} each independently represent a hydrogen atom or a C₁ to C₂₀ linear or branched alkyl,

Y¹ and Y² each independently represent a bond, —O—, —S—, or a C₁ to C₂₀ alkylene,

n and m are each independently 0 or 1,

[symbol]

when n=1 or m=1, bonds ( [symbol] ) between CRₐR_{b} and CR_{c}H are each independently a single bond,

when n=0 or m=0, bonds ( [symbol] ) between CRₐR_{b} and CR_{c}H are each independently a double bond, and

Ar represents a C₃ to C₂₀ arylene or heteroarylene.)

The polysiloxane polymer may be selected from the group consisting of polymethylhydrosiloxane (PMHS), polyethylhydrosiloxane (PEHS), polydimethylsiloxane-co-methylphenylsiloxane (silicone oil), and polymethylphenylsiloxane (PMPS).

The polysiloxane polymer may have a weight-average molecular weight (Mw) of 400 to 10,000.

The POSS may be any one or a combination of the following compounds (1′) to (6′).

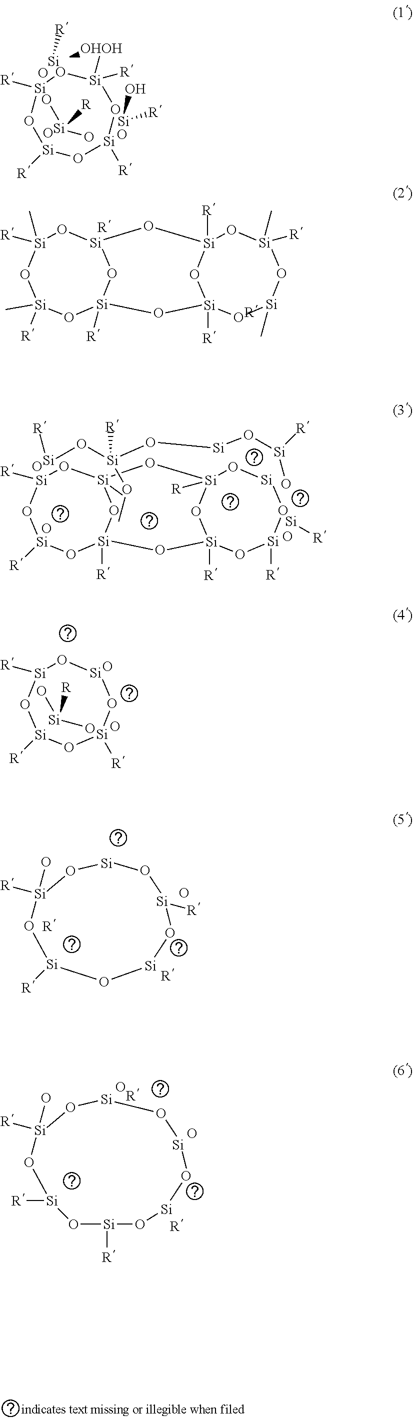

(In individual compounds (1′) to (6′), R′ is as defined in Chemical Formula 3.)

The POSS may have a cage structure.

The aromatic compound may be a compound represented by the following Chemical Formula 4.

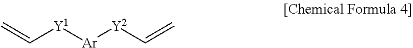

(In Chemical Formula 4,

Y¹ and Y² each independently represent a bond or a C₁ to C₂₀ alkylene, and

Ar is a C₃ to C₂₀ arylene or heteroarylene.) The aromatic compound may be selected from the group consisting of divinylbenzene (DVB) and polystyrene (PS).

The hydrosilylation may be performed under a catalyst and a solvent.

The catalyst may be a platinum (Pt) catalyst.

The solvent may be an aliphatic hydrocarbon solvent such as hexane or heptane; an aromatic hydrocarbon solvent such as anisol, mesitylene, or xylene; a ketone-based solvent such as methyl isobutyl ketone, 1-methyl-2-pyrrolidinone, cyclohexanone, or acetone; an ether-based solvent such as tetrahydrofuran or isopropyl ether; an acetate-based solvent such as ethyl acetate, butyl acetate or propylene glycol methyl ether acetate; an alcohol-based solvent such as isopropyl alcohol or butyl alcohol; an amide-based solvent such as dimethylacetamide or dimethylformamide; a silicon-based solvent; or a mixture of the above-listed solvents.

Still another aspect of the present invention provides a method of preparing porous silicon oxycarbide. The method of preparing porous silicon oxycarbide includes: hydrosilylating a linear polysiloxane polymer, a polyhedral oligomeric silsesquioxane (POSS), and an aromatic compound, in which two or more functional groups including a vinyl group or an acetylene group at a terminal thereof are substituted, to prepare an intermediate having an organosilicon bond between the linear polysiloxane polymer and the aromatic compound and between the POSS and the aromatic compound (first step); and pyrolyzing the intermediate to prepare porous silicon oxycarbide (SiOC) (second step).

A temperature of the pyrolysis may be 800 to 1200° C.

Yet another aspect of the present invention provides porous silicon oxycarbide. The porous silicon oxycarbide is prepared by the above-described method of preparing porous silicon oxycarbide and has a specific surface area of 5 to 10 m²/g and a pore volume of 0.01 to 0.05 cm³/g.

Yet another aspect of the present invention provides a lithium secondary battery. The lithium secondary battery includes: a negative electrode including the above-described porous silicon oxycarbide as a negative electrode active material; a positive electrode; and an electrolyte interposed between the negative electrode and the positive electrode.

### Advantageous Effects

According to the present invention, since an intermediate prepared by adding a polyhedral oligomeric silsesquioxane (POSS) to a reaction mixture for preparing silicon oxycarbide, which is composed of a polysiloxane polymer and an aromatic compound, is pyrolyzed to prepare porous silicon oxycarbide (SiOC), although the content of a free carbon region is lower compared to conventional silicon oxycarbide, the cage structure of the POSS is maintained in the pyrolysis to form many pores uniformly distributed in the SiOC matrix, and thus rapid diffusion of electrolyte ions is possible, and because the contents of SiO₃C and SiO₂C₂ in the SiOC matrix are increased, a reversible capacity in the Si—O—C phase can be enhanced.

Accordingly, a lithium secondary battery, which includes the porous SiOC prepared by the above method as a negative electrode active material, exhibits a high specific capacity of 900 mAh/g at a current density of 180 mA/g, and even after 200 cycles, exhibits remarkably excellent cycle stability while maintaining 94% of the initial specific capacity. Therefore, the lithium secondary battery can be widely applied in the field of energy storage that requires high capacity, high output, and high stability at the same time.

However, the technical effect of the present invention is not limited to the effect described above, and other technical effects not described above will be clearly understood by those skilled in the art from the following description.

### DESCRIPTION OF DRAWINGS

FIG. 1 is a schematic diagram showing the structure of an intermediate for preparing porous silicon oxycarbide (SiOC) according to an example of the present invention.

FIG. 2 is a schematic diagram showing the structure of an intermediate for preparing conventional SiOC according to a comparative example of the present invention.

FIG. 3 shows the Fourier transform infrared spectroscope (FT-IR) spectra before and after a reaction of an intermediate according to an example of the present invention.

FIG. 4 is the transmission electron microscope (TEM) image (FIG. 4A) and HAADF mode TEM image (FIG. 4B) of the surface of porous silicon oxycarbide prepared by pyrolyzing an intermediate according to an example of the present invention.

FIG. 5 shows the FT-IR spectra of silicon oxycarbide prepared by pyrolyzing intermediates according to a comparative example and an example of the present invention.

FIG. 6 shows the Raman spectra of silicon oxycarbide prepared by pyrolyzing intermediates according to a comparative example and an example of the present invention.

FIG. 7 shows the thermogravimetric analysis (TGA) results of silicon oxycarbide prepared by pyrolyzing intermediates according to a comparative example and an example of the present invention.

FIG. 8 shows the specific surface area analysis results of silicon oxycarbide prepared by pyrolyzing intermediates according to a comparative example and an example of the present invention.

FIG. 9 is a graph showing the output characteristics of lithium secondary batteries including silicon oxycarbide prepared by pyrolyzing intermediates according to a comparative example and an example of the present invention as a negative electrode active material.

FIG. 10 is a graph showing the cycle stability of lithium secondary batteries including silicon oxycarbide prepared by pyrolyzing intermediates according to a comparative example and an example of the present invention as a negative electrode active material.

### MODES OF THE INVENTION

Hereinafter, embodiments of the present invention will be described in detail with reference to the accompanying drawings. In describing the present invention, when it is determined that detailed description of a related known function or configuration may unnecessarily obscure the gist of the present invention, the detailed description thereof will be omitted. Also, the terms used in the specification are terms used to properly express an exemplary embodiment of the present invention, and can be changed according to the intent of users and operators or custom in the field to which the present invention belongs. Therefore, definitions of the terms should be understood on the basis of the entire description of the present invention.

Throughout the specification, when a member is referred to as being “on” another member, this encompasses not only the case in which the two members are in contact with each another but also the case in which the two members have a third member therebetween.

Throughout the specification, when a component is referred to as “containing,” “including,” “comprising,” or “having” another component, it is to be understood that this does not exclude other components but other components may be included as well, unless specifically stated otherwise.

Unless defined otherwise, all terms (including technical and scientific terms) used herein have the same meaning as commonly understood by one of ordinary skill in the art to which the present invention belongs. It will be further understood that the terms, such as those defined in commonly used dictionaries, should be interpreted as having meanings that are consistent with their meanings in the context of the relevant art, and will not be interpreted in an idealized or overly formal sense unless expressly defined otherwise herein.

As used herein, the term “alkyl” refers to a C1 to C20, specifically C1 to C10, and more specifically C1 to C6, linear or branched saturated or unsaturated hydrocarbon radical.

As used herein, the term “alkenyl” refers to a C2 to C20, specifically C2 to C10, and more specifically C2 to C6, linear or branched saturated or unsaturated hydrocarbon radical including one or more double bounds.

As used herein, the term “alkenylene” refers to a C2 to C20, specifically C2 to C10, and more specifically C2 to C6, divalent linear or branched hydrocarbon radical including one or more double bounds.

As used herein, the term “alkoxy” refers to —O-alkyl or “alkyloxy” refers to an alkyl ether radical, wherein the term “alkyl” is as defined above.

As used herein, the term “alkylene” refers to a C1 to C20, specifically C1 to C10, and more specifically C1 to C6, divalent linear or branched hydrocarbon radical.

As used herein, the term “alkynyl” refers to a C2 to C10, more specifically, C2 to C6, linear or branched hydrocarbon radical including one or more triple bonds.

As used herein, the term “aryl” refers to a polyunsaturated, aromatic, hydrocarbon radical which may be a single ring or multiple rings (one to three rings) fused or covalently bonded together.

As used herein, the term “arylene” refers to a divalent organic radical derived from an aromatic hydrocarbon by removing two hydrogen atoms, such as phenylene.

As used herein, the term “cycloalkyl” refers to a saturated or partially saturated monocyclic, bicyclic, or polycyclic alkyl radical, wherein the cyclic moiety includes 3 to 8 carbon atoms, specifically, 3 to 7 carbon atoms.

As used herein, the term “heterocyclic ring” refers to a saturated or partially saturated or aromatic monocyclic, bicyclic or polycyclic heterocyclic ring having 3 to 12 ring members, specifically 5 to 10 ring members, and more specifically 5 to 8 ring members, and includes at least one heteroatom selected from nitrogen, oxygen, and sulfur in the ring.

Intermediate for Preparing Porous Silicon Oxycarbide (SiOC)

One aspect of the present invention provides an intermediate for preparing porous silicon oxycarbide.

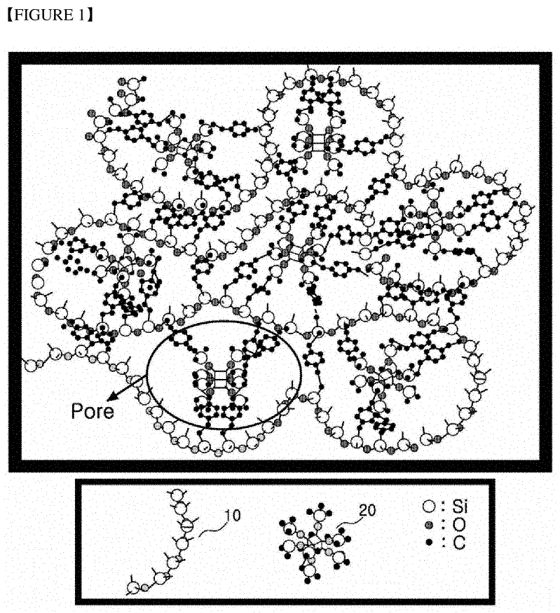

FIG. 1 is a schematic diagram showing the structure of an intermediate for preparing porous silicon oxycarbide (SiOC) according to an example of the present invention.

Referring to FIG. 1, the intermediate according to the present invention has a three-dimensional network structure and includes: main chains composed of a linear polysiloxane polymer 10; a plurality of polyhedral oligomeric silsesquioxane (POSS) moieties 20 disposed between the linear polysiloxane polymer main chains; and a bond represented by the following Chemical Formula 1, which is formed between the linear polysiloxane polymer and the POSS moiety.

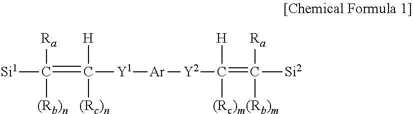

In Chemical Formula 1,

Si¹ represents a linear polysiloxane polymer,

Si² represents a POSS moiety,

Rₐ, R_{b}, and Re each independently represent a hydrogen atom or a C₁ to C₂₀ linear or branched alkyl,

Y¹ and Y² each independently represent a bond, —O—, —S—, or a C₁ to C₂₀ alkylene,

n and m are each independently 0 or 1,

when n=1 or m=1, bonds ( [symbol] ) between CRₐR_{b} and CR_{c}H are each independently a single bond,

when n=0 or m=0, bonds ( [symbol] ) between CRₐR_{b} and CR_{c}H are each independently a double bond, and

Ar represents a C₃ to C₂₀ arylene or heteroarylene, wherein the heteroarylene includes at least one of N, O, and S in the ring.

The arylene may be phenylene, biphenylene, naphthalene, anthrylene, or the like, and the heteroarylene may be thienylene, thiophenylene, pyridinylene, pyrrolylene, fluorenylene, or the like.

Ar may be optionally substituted with an alkyl, aryl, cycloalkyl, halogen, hydroxy, alkoxy, thioalkyl, amino, amino derivative, amido, amidoxy, nitro, cyano, keto, acyl derivative, acyloxy derivative, carboxy, ester, ether, esteroxy, heterocyclic ring, alkenyl, or alkynyl.

The intermediate may be in the form of an aerogel, but the present invention is not limited thereto. The aerogel is a porous solid nanostructure in which gas is contained in the gap when aerosol particles settle and come into contact with each other.

The polysiloxane polymer 10 serves as a main chain constituting a network structure in the intermediate of the present invention. The polysiloxane polymer 10 may be included in an amount of 50 to 90 parts by weight based on 100 parts by weight of the intermediate, but the present invention is not limited thereto.

The POSS moiety 20 serves to widen a space between linear polysiloxane polymers by being disposed between the linear polysiloxane polymer main chains in the intermediate to form many pores in subsequently prepared silicon oxycarbide and also serves to supply oxygen elements to the inside of the intermediate to form oxygen-rich silicon oxycarbide after pyrolysis.

The POSS moiety 20 may be any one or a combination of the following compounds (1) to (6). Specifically, the compound (1) has a partial cage structure, the compound (2) has a ladder structure, and the compound (3) has a random structure. The compound (4) is a case in which n in (R—SiO_{1.5})ₙ is 8, the compound (5) is a case in which n in (R—SiO_{1.5})ₙ is 10, and the compound (6) has a molecular structure including one cage when n in (R—SiO_{1.5})ₙ is 12.

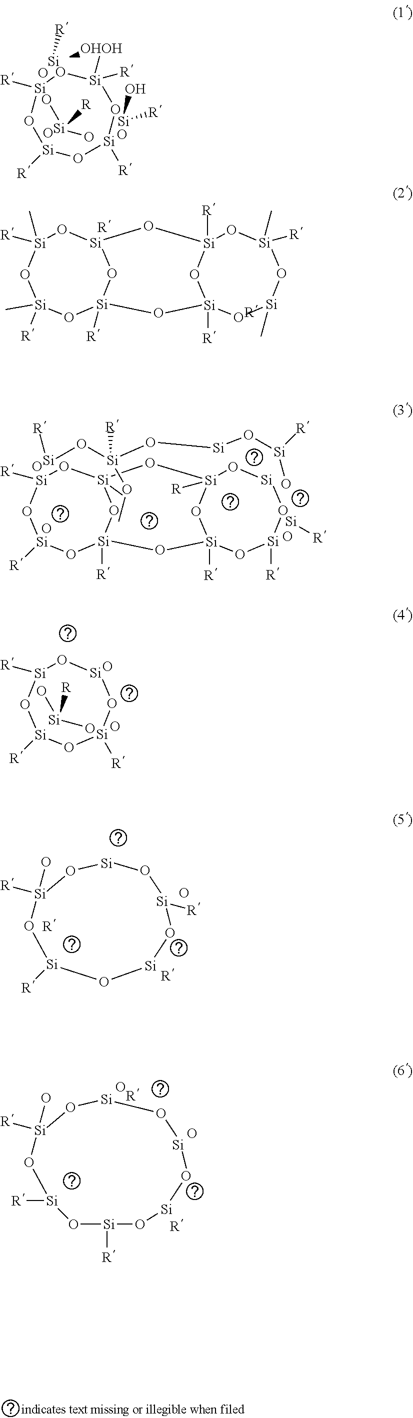

In the individual compounds (1) to (6), at least two Rs each independently represent —OSi²R^{A}R^{B}—*, wherein R^{A} and R^{B} represent any one of a hydrogen atom, a halogen atom, a hydroxy, and a C₁ to C₂₀ linear or branched alkyl, alkene, alkyne, or alkoxy, and

the remaining Rs each independently represent any one of a hydrogen atom, a halogen atom, a hydroxy, a C₁ to C₂₀ linear or branched alkyl, alkene, alkyne, or alkoxy, a C₅ to C₂₀ aryl, and —OSir¹r²r³, wherein r¹, r², and r³ each independently represent any one of a hydrogen atom, a halogen atom, a hydroxy, and a C₁ to C₂₀ linear or branched alkyl, alkene, alkyne, or alkoxy.

The POSS moiety 20 may have a cage structure.

The POSS moiety 20 may be included in an amount of less than 3 parts by weight based on 100 parts by weight of the intermediate. Within the above-described range, the dispersibility of electrolyte ions can be enhanced through pores formed by the POSS moiety. When the POSS moiety is excessively included, a certain amount or more of free carbon is decreased during SiOC preparation, and thus a discontinuous free carbon site in the SiOC structure may interfere with electron transfer, thereby leading to a decrease in electrochemical performance.

Another aspect of the present invention provides a method of preparing an intermediate for preparing porous silicon oxycarbide.

The method of preparing an intermediate includes hydrosilylating a linear polysiloxane polymer, a polyhedral oligomeric silsesquioxane (POSS), and an aromatic compound, in which two or more functional groups including a vinyl group or an acetylene group at a terminal thereof are substituted, to form an organosilicon bond between the linear polysiloxane polymer and the aromatic compound and between the POSS and the aromatic compound.

The linear polysiloxane polymer may have a repeat unit represented by the following Chemical Formula 2.

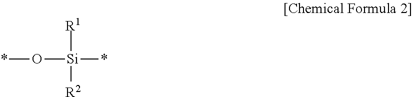

In Chemical Formula 2,

R¹ and R² each independently represent a hydrogen atom or a C₁ to C₂₀ linear or branched alkyl, and

at least one of R¹ and R² represents a hydrogen atom.

The POSS may be represented by the following Chemical Formula 3.

(R′—SiO_{1.5})ₙ [Chemical Formula 3]

In Chemical Formula 3,

n is 8 to 16, at least two of the 8 to 16 R′s represent —OSi²HR^{A}R^{B} involved in the hydrosilylation, wherein R^{A} and R^{B} represent any one of a hydrogen atom, a halogen atom, a hydroxy, and a C₁ to C₂₀ linear or branched alkyl, alkene, alkyne, or alkoxy, and

the remaining Rs each independently represent any one of a hydrogen atom, a halogen atom, a hydroxy, a C₁ to C₂₀ linear or branched alkyl, alkene, alkyne, or alkoxy, a C₅ to C₂₀ aryl, and —OSir¹r²r³, wherein r¹, r², and r³ each independently represent any one of a hydrogen atom, a halogen atom, a hydroxy, and a C₁ to C₂₀ linear or branched alkyl, alkene, alkyne, or alkoxy.

The organosilicon bond between the linear polysiloxane polymer and the aromatic compound and between the POSS and the aromatic compound may be represented by the following Chemical Formula 1.

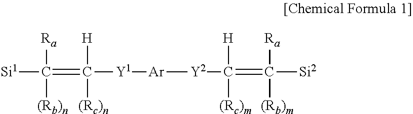

In Chemical Formula 1,

Si¹ represents a linear polysiloxane polymer,

Si² represents a POSS,

Rₐ, R_{b}, and R_{c} each independently represent a hydrogen atom or a C₁ to C₂₀ linear or branched alkyl,

Y¹ and Y² each independently represent a bond, —O—, —S—, or a C₁ to C₂₀ alkylene,

n and m are each independently 0 or 1,

when n=1 or m=1, bonds ( [symbol] ) between CRₐR_{b} and CR_{c}H are each independently a single bond,

when n=0 or m=0, bonds ( [symbol] ) between CRₐR_{b} and CR_{c}H are each independently a double bond, and

Ar represents a C₃ to C₂₀ arylene or heteroarylene.

The polysiloxane polymer may be selected from the group consisting of polymethylhydrosiloxane (PMHS), polyethylhydrosiloxane (PEHS), polydimethylsiloxane-co-methylphenylsiloxane (silicone oil), and polymethylphenylsiloxane (PMPS).

The polysiloxane polymer may have a weight-average molecular weight (Mw) of 400 to 10,000.

The POSS may be any one or a combination of the following compounds (1′) to (6′).

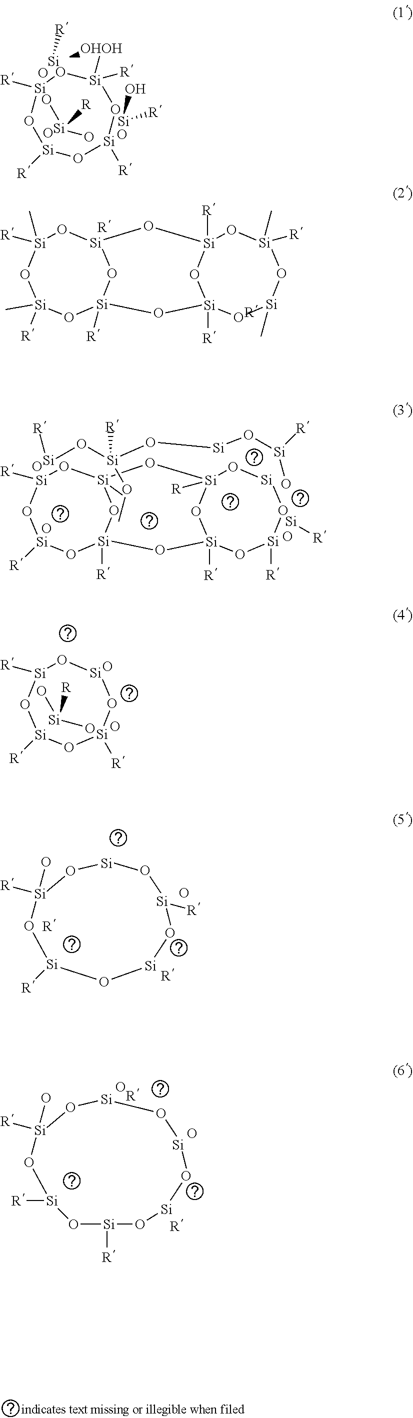

(In individual compounds (1) to (6), R′ is as defined in Chemical Formula 3.)

The POSS may have a cage structure.

The aromatic compound may be a compound represented by the following Chemical Formula 4.

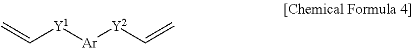

In Chemical Formula 4,

Y¹ and Y² each independently represent a bond or a C₁ to C₂₀ alkylene, and

Ar is a C₃ to C₂₀ arylene or heteroarylene, wherein the heteroarylene includes at least one of N, O, and S in the ring.

The arylene may be phenylene, biphenylene, naphthalene, anthrylene, or the like, and the heteroarylene may be thienylene, thiophenylene, pyridinylene, pyrrolylene, fluorenylene, or the like.

Ar may be optionally substituted with an alkyl, aryl, cycloalkyl, halogen, hydroxy, alkoxy, thioalkyl, amino, amino derivative, amido, amidoxy, nitro, cyano, keto, acyl derivative, acyloxy derivative, carboxy, ester, ether, esteroxy, heterocyclic ring, alkenyl, or alkynyl.

The aromatic compound may be selected from the group consisting of divinylbenzene (DVB) and polystyrene (PS).

The aromatic compound may be added in an amount of 150 to 300 parts by weight based on 100 parts by weight of the linear polysiloxane polymer.

The hydrosilylation may be performed under a catalyst and a solvent.

The catalyst may be a platinum (Pt) catalyst. The catalyst may be used in a molar ratio relative to the linear polysiloxane polymer of 1:0.00001 to 1:10, but the present invention is not limited thereto.

The solvent may be, for example, an aliphatic hydrocarbon solvent such as hexane or heptane; an aromatic hydrocarbon solvent such as anisol, mesitylene, or xylene; a ketone-based solvent such as methyl isobutyl ketone, 1-methyl-2-pyrrolidinone, cyclohexanone, or acetone; an ether-based solvent such as tetrahydrofuran or isopropyl ether; an acetate-based solvent such as ethyl acetate, butyl acetate or propylene glycol methyl ether acetate; an alcohol-based solvent such as isopropyl alcohol or butyl alcohol; an amide-based solvent such as dimethylacetamide or dimethylformamide; a silicon-based solvent; or a mixture of the above-listed solvents.

The hydrosilylation may be performed at 100 to 200° C. for 4 to 10 hours.

As shown in the following Reaction Scheme 1, in crosslinking (hydrosilylation) between a polysiloxane polymer having a Si—H group and an organic substance (aromatic compound) having a vinyl group in the presence of a platinum catalyst, a POSS is added, and thus Si—H in a terminal of the POSS participates in the hydrosilylation of the polysiloxane polymer and the aromatic compound. As a result, as shown in FIG. 1, an aerogel-type intermediate with a structure in which an organosilicon bond is formed between the linear polysiloxane polymer and the aromatic compound and between the POSS and the aromatic compound is formed.

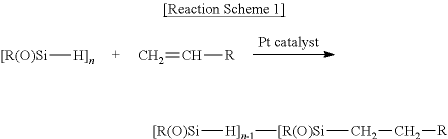

Method of Preparing Porous Silicon Oxycarbide (SiOC)

Still another aspect of the present invention provides a method of preparing porous silicon oxycarbide (SiOC).

The porous silicon oxycarbide (SiOC) may be prepared by pyrolyzing the above-described intermediate.

Specifically, the method of preparing porous silicon oxycarbide includes: hydrosilylating a linear polysiloxane polymer, a polyhedral oligomeric silsesquioxane (POSS), and an aromatic compound, in which two or more functional groups including a vinyl group or an acetylene group at a terminal thereof are substituted, to prepare an intermediate having an organosilicon bond between the linear polysiloxane polymer and the aromatic compound and between the POSS and the aromatic compound (first step); and pyrolyzing the intermediate to prepare porous silicon oxycarbide (SiOC) (second step).

Specifically, the first step is intended to prepare an intermediate. Since the preparation of an intermediate has been described above, further details will be omitted to avoid duplicate description.

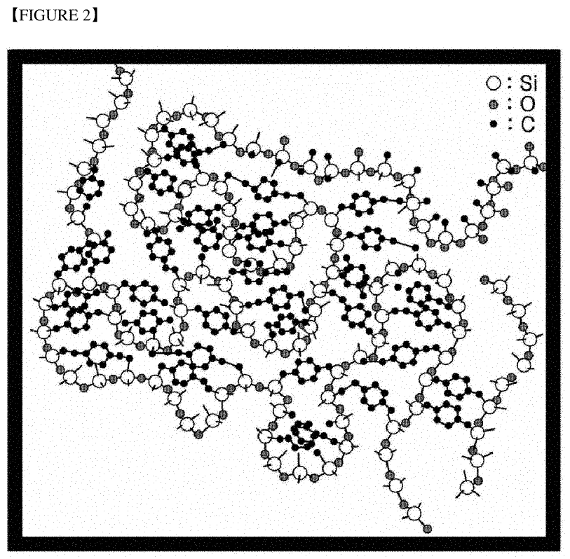

As described above, the intermediate prepared in the first step is formed to have an organosilicon bond between the linear polysiloxane polymer and the aromatic compound and between the POSS and the aromatic compound by participation of a POSS with a cage structure in hydrosilylation, and thus has a structure completely different from that of a conventional intermediate formed by crosslinking of a linear polysiloxane polymer and an aromatic compound without inclusion of POSS (FIG. 2).

Next, the second step is intended to prepare porous silicon oxycarbide (SiOC) by pyrolyzing the intermediate.

A temperature of the pyrolysis may be 800 to 1200° C.

The intermediate prepared with addition of POSS according to the present invention may maintain the cage frame of the POSS even after being pyrolyzed and contribute to formation of nanopores as a portion of a Si—O—C phase. Also, a space between a free carbon region and a Si—O—C matrix, which is formed by steric hindrance of the POSS, may also remain as a pore. Therefore, the SiOC prepared according to the present invention may have a porous structure having a BET specific surface area of 5 to 10 m²/g and a pore volume of 0.01 to 0.05 cm³/g.

On the other hand, in the case of conventional SiOC prepared by pyrolyzing an intermediate including a polysiloxane polymer, a Si—O—C matrix and a free carbon region are relatively densely formed.

However, in the case of the porous SiOC according to the present invention, the growth of free carbon clusters is inhibited due to steric hindrance of the POSS in the pyrolysis, and thus a content of a free carbon region and a particle size are decreased.

Since the porous SiOC according to the present invention is prepared by pyrolyzing an intermediate prepared by adding a POSS to a reaction mixture composed of a polysiloxane polymer and an aromatic compound, although the content of a free carbon region is lower compared to conventional silicon oxycarbide, the cage structure of the POSS is maintained in the pyrolysis to form many pores uniformly distributed in the SiOC matrix, and thus rapid diffusion of electrolyte ions is possible, and because the contents of SiO₃C and SiO₂C₂ in the SiOC matrix are increased, a reversible capacity in the Si—O—C phase can be enhanced.

Lithium Secondary Battery

Yet another aspect of the present invention provides a lithium secondary battery.

The lithium secondary battery according to the present invention includes: a negative electrode; a positive electrode; and an electrolyte interposed between the negative electrode and the positive electrode. For example, the lithium secondary battery may be fabricated by interposing a porous separator between a positive electrode and a negative electrode and injecting a lithium salt-containing electrolyte.

In this case, the negative electrode includes the above-described porous silicon oxycarbide as a negative electrode active material.

The lithium metal secondary battery according to an embodiment of the present invention is not limited to this shape, and of course any shape that is able to be operated as a battery with inclusion of the electrolyte according to an embodiment of the present invention, such as a cylindrical shape, a coin shape, a pouch, or the like, is possible.

Negative Electrode

The negative electrode may include a negative electrode active material.

The negative electrode may be manufactured by applying a slurry including a negative electrode active material, a conductive material, and a binder onto a negative electrode current collector, followed by compressing and drying.

In this case, the above-described porous silicon oxycarbide may be used as the negative electrode active material. Since the porous silicon oxycarbide has been described above, further details will be omitted to avoid duplicate description.

As the conductive material, any conductive material that can be typically used in the art may be used without limitation. For example, artificial graphite, natural graphite, carbon black, acetylene black, ketjen black, denka black, thermal black, channel black, carbon fiber, metal fiber, aluminum, tin, bismuth, silicon, antimony, nickel, copper, titanium, vanadium, chromium, manganese, iron, cobalt, zinc, molybdenum, tungsten, silver, gold, lanthanum, ruthenium, platinum, iridium, titanium oxide, polyaniline, polythiophene, polyacetylene, polypyrrole, or a mixture thereof may be used.

As the binder, any binder that can be typically used in the art may be used without limitation. For example, polyvinylidene fluoride (PVdF), a polyvinylidene fluoride-polyhexafluoropropylene copolymer (PVdF/HFP), poly(vinyl acetate), polyvinyl alcohol, polyethylene oxide, polyvinylpyrrolidone, polyvinylpyridine, an alkylated polyethylene oxide, polyvinyl ether, poly(methyl methacrylate), poly(ethyl acrylate), polytetrafluoroethylene (PTFE), polyvinyl chloride, polyacrylonitrile, styrene-butadiene rubber, acrylonitrile-butadiene rubber, fluoro-rubber, an ethylene-propylene-diene monomer (EPDM), a sulfonated EPDM, carboxymethylcellulose (CMC), regenerated cellulose, starch, hydroxypropylcellulose, tetrafluoroethylene, or a mixture thereof may be used.

The negative electrode current collector is typically made to have a thickness of 3 to 500 μm. The negative electrode current collector is not particularly limited as long as it does not cause a chemical change in the battery and has conductivity. For example, copper, stainless steel, aluminum, nickel, titanium, calcined carbon, copper or stainless steel whose surface has been treated with carbon, nickel, titanium, silver, or the like, or an aluminum-cadmium alloy may be used. Also, the negative electrode current collector may have fine irregularities formed on the surface thereof to increase the adhesion of the negative electrode active material and may be used in any of various forms such as a film, a sheet, a foil, a net, a porous material, a foam, a non-woven fabric, and the like.

The solvent used in the slurry for forming the negative electrode may be water or an organic solvent such as N-methyl pyrrolidone (NMP), dimethylformamide (DMF), acetone, dimethylacetamide, or the like, which may be used alone or in a combination of two or more thereof.

The solvent may be used in an amount just enough to dissolve or disperse the electrode active material, binder, and conductive material in consideration of a thickness of an applied slurry and a manufacturing yield.

Positive Electrode

The positive electrode may be manufactured by a typical method known in the art and include a positive electrode active material, a binder, and a conductive material. Also, as the positive electrode, a lithium metal or lithium alloy may be used.

The positive electrode active material of the lithium secondary battery may include a lithium-transition metal oxide or a lithium-transition metal phosphate.

The lithium-transition metal oxide may be a composite oxide including lithium and at least one transition metal selected from the group consisting of cobalt, manganese, nickel, and aluminum. The lithium-transition metal oxide may be, for example, Li(Ni_{1-x-y}CoₓMn_{y})O₂ (0≤x≤1, 0≤y≤1, 0≤x+y≤1), Li(Ni_{1-x-y}CoₓAl_{y})O₂ (0≤x≤1, 0<y≤1, 0<x+y≤1), or Li(Ni_{1-x-y}CoₓMn_{y})₂O₄ (0≤x≤1, 0≤y≤1, 0≤x+y≤1). The lithium-transition metal phosphate may be a composite phosphate including lithium and at least one transition metal selected from the group consisting of iron, cobalt, and nickel. The lithium-transition metal phosphate may be, for example, Li(Ni_{1-x-y}CoₓFe_{y})PO₄ (0≤x≤1, 0≤y≤1, 0≤x+y≤1).

The positive electrode current collector is typically made to have a thickness of 3 to 500 μm. The positive electrode current collector is not particularly limited as long as it does not cause a chemical change in the battery and has conductivity, and any metal that has high conductivity, allows the positive electrode active material slurry to be easily adhered, and has no reactivity in a battery voltage range may be used. Non-limiting examples of the positive electrode current collector include a foil made of aluminum, nickel, or a combination thereof.

The solvent for forming the positive electrode may be water or an organic solvent such as N-methyl pyrrolidone (NMP), dimethylformamide (DMF), acetone, dimethylacetamide, or the like, which may be used alone or in a combination of two or more thereof.

The solvent may be used in an amount just enough to dissolve or disperse the electrode active material, binder, and conductive material in consideration of a thickness of an applied slurry and a manufacturing yield.

As the conductive material, any conductive material that can be typically used in the art may be used without limitation. For example, artificial graphite, natural graphite, carbon black, acetylene black, ketjen black, denka black, thermal black, channel black, carbon fiber, metal fiber, aluminum, tin, bismuth, silicon, antimony, nickel, copper, titanium, vanadium, chromium, manganese, iron, cobalt, zinc, molybdenum, tungsten, silver, gold, lanthanum, ruthenium, platinum, iridium, titanium oxide, polyaniline, polythiophene, polyacetylene, polypyrrole, or a mixture thereof may be used.

As the binder, any binder that can be typically used in the art may be used without limitation. For example, polyvinylidene fluoride (PVdF), a polyvinylidene fluoride-polyhexafluoropropylene copolymer (PVdF/HFP), poly(vinyl acetate), polyvinyl alcohol, polyethylene oxide, polyvinylpyrrolidone, polyvinylpyridine, an alkylated polyethylene oxide, polyvinyl ether, poly(methyl methacrylate), poly(ethyl acrylate), polytetrafluoroethylene (PTFE), polyvinyl chloride, polyacrylonitrile, styrene-butadiene rubber, acrylonitrile-butadiene rubber, fluoro-rubber, an ethylene-propylene-diene monomer (EPDM), a sulfonated EPDM, carboxymethylcellulose (CMC), regenerated cellulose, starch, hydroxypropylcellulose, tetrafluoroethylene, or a mixture thereof may be used.

As necessary, the positive electrode may further include a filler. The filler is a component for suppressing expansion of the positive electrode, is optionally used, and is not particularly limited as long as it does not cause a chemical change in the battery and is a fibrous material. For example, an olefin-based polymer such as polyethylene, polypropylene, or the like; or a fibrous material such as glass fiber, carbon fiber, or the like is used.

Electrolyte

The electrolyte is a lithium salt-containing non-aqueous electrolyte, which is composed of a non-aqueous electrolyte and a lithium salt. As the non-aqueous electrolyte, a non-aqueous liquid electrolyte, a solid electrolyte, an inorganic solid electrolyte, or the like is used.

As the non-aqueous liquid electrolyte, for example, an aprotic organic solvent such as N-methyl-2-pyrrolidinone, ethylene carbonate, propylene carbonate, butylene carbonate, dimethyl carbonate, diethyl carbonate, ethyl methyl carbonate, γ-butyrolactone, 1,2-dimethoxyethane, tetrahydrofuran, 2-methyl tetrahydrofuran, dimethyl sulfoxide, 1,3-dioxolane, formamide, dimethylformamide, dioxolane, acetonitrile, nitromethane, methyl formate, methyl acetate, phosphate triester, trimethoxy methane, a dioxolane derivative, sulfolane, methyl sulfolane, 1,3-dimethyl-2-imidazolidinone, a propylene carbonate derivative, a tetrahydrofuran derivative, an ether, methyl propionate, ethyl propionate, or the like may be used.

As the organic solid electrolyte, for example, a polyethylene derivative, a polyethylene oxide derivative, a polypropylene oxide derivative, a phosphate ester polymer, polyagitation lysine, polyester sulfide, polyvinyl alcohol, polyvinylidene fluoride, a polymer including an ionic dissociation group, or the like may be used.

As the inorganic solid electrolyte, for example, a nitride, halide, sulfate, or the like of Li, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, or the like may be used.

As the lithium salt, a substance that dissolves well in the non-aqueous electrolyte, for example, LiCl, LiBr, LiI, LiClO₄, LiBF₄, LiBioClio, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloroborane lithium, lower aliphatic lithium carboxylates, 4-phenyl lithium borate, an imide, or the like, may be used.

In addition, in order to improve charging/discharging characteristics, flame retardancy, and the like, the non-aqueous electrolyte may include, for example, pyridine, triethyl phosphite, triethanolamine, cyclic ether, ethylene diamine, n-glyme, hexaphosphorous triamide, a nitrobenzene derivative, sulfur, a quinone imine dye, N-substituted oxazolidinone, N,N-substituted imidazolidine, an ethylene glycol dialkyl ether, an ammonium salt, pyrrole, 2-methoxy ethanol, aluminum trichloride, or the like. In some cases, a halogen-containing solvent such as carbon tetrachloride, ethylene trifluoride, or the like may be further included to impart non-flammability, and carbon dioxide gas may be further included to enhance high-temperature preservation characteristics.

Separator

A separator that insulates the electrodes may be used between the positive electrode and the negative electrode. As the separator, a typical porous polymer film conventionally used as a separator, for example, a porous polymer film made of a polyolefin-based polymer such as an ethylene homopolymer, a propylene homopolymer, an ethylene/butene copolymer, an ethylene/hexene copolymer, an ethylene/methacrylate copolymer, or the like, may be used alone or by stacking them, or a typical porous non-woven fabric, for example, a non-woven fabric made of high-melting-point glass fiber, polyethylene terephthalate fiber, or the like may be used, but the present invention is not limited thereto.

Battery Module

The lithium secondary battery according to the present invention may be used not only in a battery module used as a power source of a small-sized device but also as a unit battery in a medium-to-large-sized battery pack including a plurality of batteries. The battery module according to yet another aspect of the present invention includes the above-described lithium secondary battery as a unit battery, and the battery pack according to yet another aspect of the present invention includes the battery module.

Examples of the medium-to-large-sized device include electric vehicles, hybrid electric vehicles, plug-in hybrid electric vehicles, energy storage systems, and the like, but the present invention is not limited thereto.

As a battery case used in the present invention, any battery case typically used in the art may be selected, and although there is no limitation in shape according to the use of the battery, for example, a cylindrical form using a can, a prismatic form, a pouch form, a coin form, or the like may be used.

Hereinafter, exemplary preparation examples (examples) and experimental examples will be provided to facilitate understanding of the present invention. However, the following preparation examples and experimental examples are provided only to facilitate understanding of the present invention and are not intended to limit the present invention.

### Preparation of Intermediate: Preparation Examples 1 to 3 and Comparative Example 1

### Preparation Example 1

8 g of acetone, 0.8 g of polymethylhydrosiloxane (PMHS), 0.2 g of pss-octakis(dimethylsilyloxy)silsesquioxane as a POSS, and 1.6 g of divinylbenzene (DVB) were continuously mixed, a platinum catalyst was added to the mixing solution, and then stirring was sufficiently performed.

The mixing solution was input into an autoclave and heated at 120° C. for 6 hours to synthesize an intermediate in the form of an aerogel.

The intermediate was taken out of the autoclave and stored in acetone for a day to remove an unreacted polymer and catalyst. After the removal process was repeated for 5 days, the resulting intermediate was dried in a vacuum oven at 60° C. overnight to obtain a final intermediate with a structure of FIG. 1.

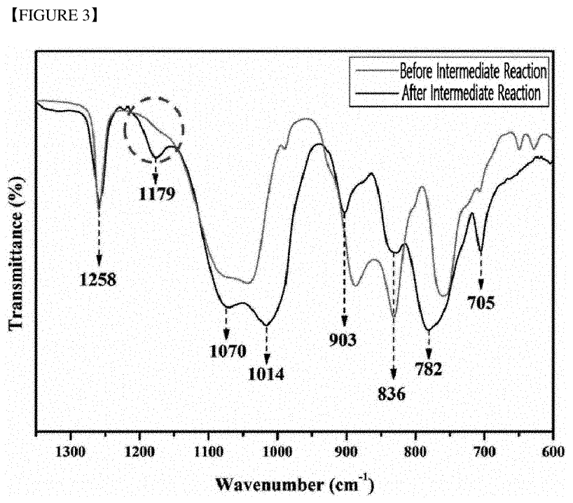

FIG. 3 shows the Fourier transform infrared spectroscope (FT-IR) spectra before and after a reaction of the intermediate prepared according to an example of the present invention.

As shown in FIG. 3, as compared with the mixture of the polysiloxane polymer, POSS, and DVB, which is a reaction mixture before a reaction, a peak related to a Si—C bond was exhibited at 1179 cm⁻¹ in the IR spectrum of the product of hydrosilylation after the reaction. From this result, it was confirmed that the intermediate was successfully produced.

### Preparation Example 2

An intermediate for preparing porous SiOC was prepared in the same manner as in Preparation Example 1, except that 0.1 g of pss-octakis(dimethylsilyloxy)silsesquioxane was used.

### Preparation Example 3

An intermediate for preparing porous SiOC was prepared in the same manner as in Preparation Example 1, except that 0.3 g of pss-octakis(dimethylsilyloxy)silsesquioxane was used.

### Comparative Example 1

An intermediate for preparing SiOC with a structure of FIG. 2 was prepared in the same manner as in Preparation Example 1, except that pss-octakis(dimethylsilyloxy)silsesquioxane was not added.

### Preparation of Silicon Oxycarbide (SiOC): Preparation Examples 4 to 6 and Comparative Example 2

### Preparation Examples 4 to 6

The intermediates prepared in Preparation Examples 1 to 3 were heated to 900° C. at a heating rate of 5° C./min under an Ar atmosphere and then pyrolyzed by thermal treatment in a tube furnace at 900° C. for an hour to obtain porous SiOC products.

### Comparative Example 2

A SiOC product was obtained by pyrolyzing the intermediate prepared in Comparative Example 1 under the same conditions as in Preparation Example 4.

### Fabrication of Lithium Secondary Battery: Preparation Examples 7 to 9 and Comparative Example 3

### Preparation Example 7

The porous SiOC prepared in Preparation Example 4 was used as a negative electrode active material, and using a ball mill, the negative electrode active material, carbon black (Super P, TIMCAL Graphite & Carbon), and a polyacrylic acid (PAA; M.W. 160,000, Sigma-Aldrich) binder were input in a weight ratio of 85:5:10 into water and mixed to form a slurry.

The slurry was casted on a copper foil using a doctor blade, compressed using a roll press, and then dried in an 80° C. vacuum oven overnight. The coated copper foil was cut to a diameter of 14 mm so that the amount of the active material loaded in a negative electrode was about 1 mg cm².

In order to fabricate a coin cell, the electrode was allowed to move to a glove box filled with argon. A Li metal as a counter electrode (positive electrode), Celgard 2400 as a separator, and a solvent prepared by dissolving 1 M LiPF₆ in a solvent mixture of ethylene carbonate, ethyl methyl carbonate, and dimethyl carbonate (in a mixing ratio of 1:1:1) as an electrolyte were used to fabricate a 2032-coin cell.

### Preparation Examples 8 and 9

A 2032-coin cell was fabricated in the same manner as in Preparation Example 7, except that the porous SiOC prepared in Preparation Example 5 or 6 instead of Preparation Example 4 was used as a negative electrode active material.

### Comparative Example 3

A 2032-coin cell was fabricated in the same manner as in Preparation Example 7, except that the SiOC prepared in Comparative Example 2 instead of Preparation Example 4 was used as a negative electrode active material.

### EXPERIMENTAL EXAMPLES

### Experimental Example 1: Analysis of Structure and Material Properties of Silicon Oxycarbide

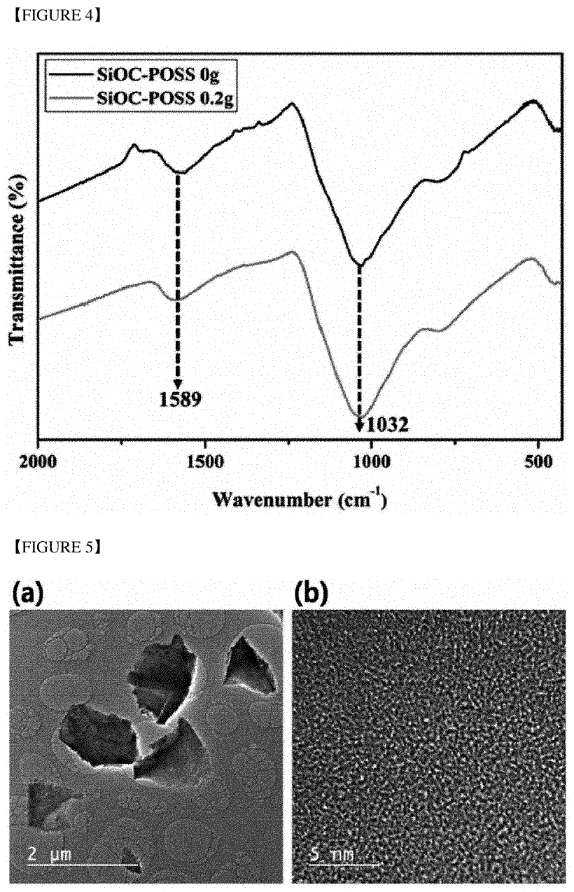

FIG. 4 is the transmission electron microscope (TEM) image (FIG. 4A) and HAADF mode TEM image (FIG. 4B) of the surface of porous silicon oxycarbide prepared by pyrolyzing the intermediate according to an example of the present invention.

As shown in FIG. 4, as a result of observing the surface of the prepared SiOC particle (FIG. 4A) with magnification, as shown in FIG. 4B, it was confirmed that numerous pores were formed on the surface.

FIG. 5 shows the FT-IR spectra of silicon oxycarbide prepared by pyrolyzing intermediates according to a comparative example and an example of the present invention.

As shown in FIG. 5, the SiOC prepared according to the present invention exhibited a peak related to a Si—O—Si stretching bond at 1032 cm⁻¹ and a peak related to a C═C bond of free carbon at about 1589 cm⁻¹. From this result, it was confirmed that SiOC was successfully produced.

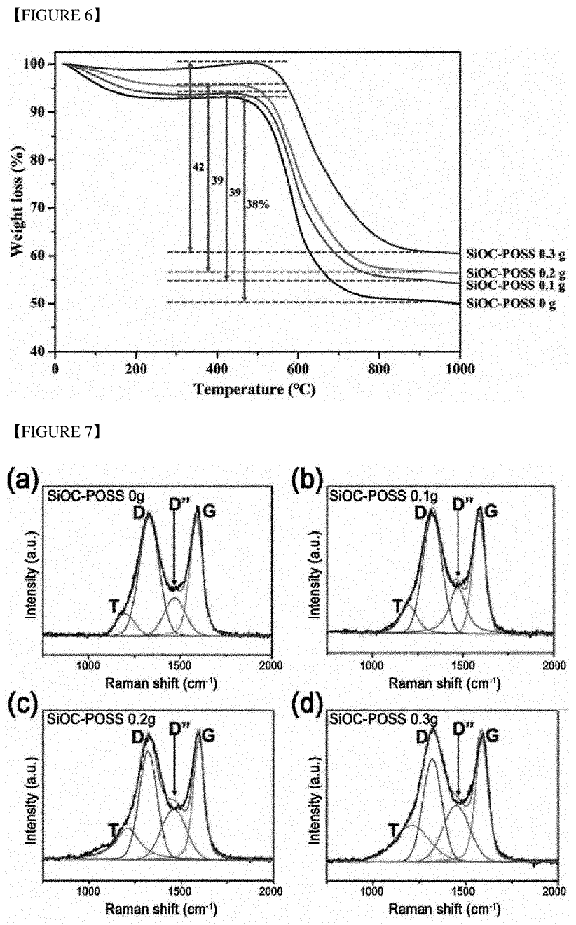

FIG. 6 shows the Raman spectra of silicon oxycarbide prepared by pyrolyzing intermediates according to a comparative example and an example of the present invention.

A typical Raman spectrum of a carbon material generally exhibits two important bands, that is, a D-band and a G-band. The D-band is caused by disordered vibration of 6-coordinated aromatic rings, whereas the G-band is associated with plane-bonded stretching vibration of sp²-hybridized carbon pairs. The D-band and G-band of the carbon material were observed at 1330 cm⁻¹ and 1590 cm⁻¹, respectively.

In addition, deconvolution of a Raman spectrum produces a T-band and a D″-band, which are produced due to the presence of an sp²-sp³-C bond and a fraction of amorphous carbon, respectively, and are exhibited at about 1200 cm⁻¹ and 1460 cm⁻¹, respectively.

As shown in FIG. 6, the intensities of the T-band and D″-band increased as a POSS content was increased, which suggests that the number of edges and defect sites in graphene increased.

The carbon ordering degree and crystal size (Lₐ) of a carbon cluster may be defined by the intensity ratio (I_{D}/I_{G}) of the deconvoluted peak and Equation 1, as suggested by Ferrari and Robertson.

I_{D}/I_{G}=C′(λ)Lₐ² [Equation 1]

In Equation 1, C′ represent a coefficient dependent on the excitation wavelength of a laser,

C′(514 nm) is about 0.0055 Å, and

Lₐ represents a crystal size.

The I_{D}/I_{G} and Lₐ values of the SiOC prepared in Comparative Example 2 and Preparation Examples 4 to 6 of the present invention are shown in the following Table 1.

TABLE 1

| | POSS | | |
|---|---|---|---|
| | content (g) | I_{D}/I_{G} | Lₐ (Å) |
| Comparative Example 2 | 0 | 1.07 | 13.92 |
| Preparation Example 5 | 0.1 | 1.04 | 13.75 |
| Preparation Example 4 | 0.2 | 0.91 | 12.86 |
| Preparation Example 6 | 0.3 | 0.85 | 12.43 |

Referring to FIG. 6 and Table 1, as a POSS content was increased, the intensity of the D-band gradually decreased, and the intensity ratios (I_{D}/I_{G}) of 1.07, 1.04, 0.91, and 0.85 were exhibited. Furthermore, as a POSS content was increased, the crystal size (Lₐ) of a carbon cluster decreased from 13.92 Å to 13.75 Å, 12.86 Å, and finally 12.43 Å. It can be seen that the results are caused by addition of POSS, and the POSS partially inhibits the growth of carbon clusters.

Meanwhile, quantitative analysis of the free carbon phase present in the POSS-added SiOC provided essential information for determining electrochemical performance, which can be confirmed using the thermochemical analysis results of SiOC samples. As quantified by thermal analysis, the amount of free carbon was obtained from C atoms not bound to Si atoms. The weight change of the pyrolyzed SiOC according to a change in POSS content was measured in an air flow at 0° C. to 1000° C. through thermogravimetric analysis (TGA), and results thereof are shown in FIG. 7.

FIG. 7 shows the TGA results of silicon oxycarbide prepared by pyrolyzing intermediates according to a comparative example and an example of the present invention.

As shown in FIG. 7, SiOC samples prepared by adding 0 g, 0.1 g, 0.2 g, and 0.3 g of a POSS exhibited 42%, 39%, 39%, and 38% weight loss in the range of 450° C. to 900° C., respectively. From this result, it was confirmed that, as a POSS content was increased, the amount of free carbon present in the pyrolyzed SiOC decreased.

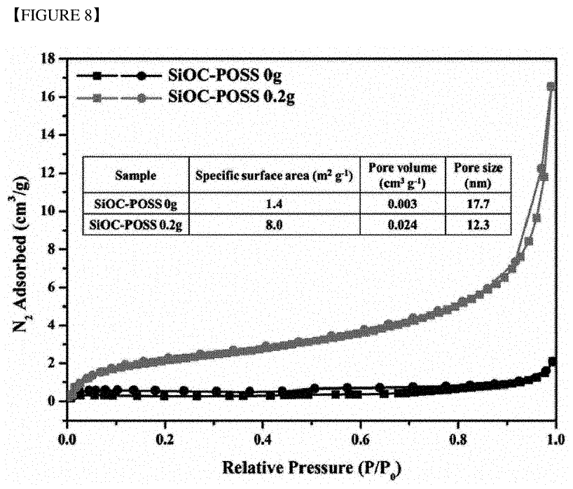

FIG. 8 shows the BET specific surface area analysis results of silicon oxycarbide prepared by pyrolyzing intermediates according to a comparative example and an example of the present invention.

As shown in FIG. 8, it was confirmed that the silicon oxycarbide according to the present invention, which had many pores formed by addition of a POSS, exhibited a BET specific surface area of 8.0 m²/g and thus had a specific surface area about 6 times that (1.4 m²/g) of the silicon oxycarbide of the comparative examples in which a POSS was not added. Also, it exhibited a pore volume of 0.024 cm³/g and thus had a pore volume 8 times that (0.003 cm³/g) of the silicon oxycarbide of the comparative examples in which a POSS was not added.

### Experimental Example 2: Analysis of Electrochemical Properties of Secondary Battery

In order to examine the electrochemical properties of the secondary battery including the porous SiOC negative electrode active material according to the present invention, an experiment was performed as follows.

The secondary battery including the porous SiOC negative electrode active material according to the present invention was subjected to galvanostatic charging/discharging between 0.001 V and 3 V for output characteristic and cycle stability tests. For a rate performance test, a charge/discharge current density was gradually increased from 72 mA g⁻¹ to 3600 mA g⁻¹, and for a cycle stability test, a current density of 360 mA g⁻¹ was applied.

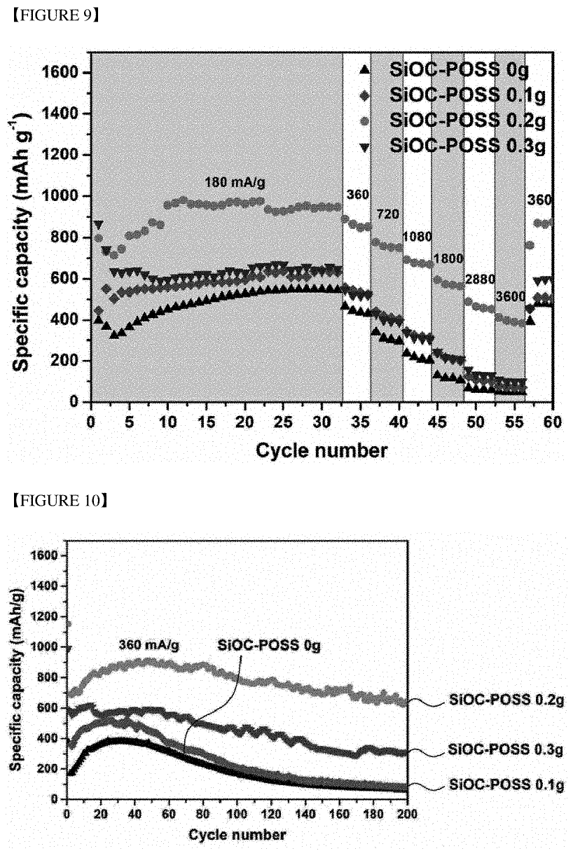

FIG. 9 is a graph showing the output characteristics of lithium secondary batteries including silicon oxycarbide prepared by pyrolyzing intermediates according to a comparative example and an example of the present invention as a negative electrode active material.

FIG. 10 is a graph showing the cycle stability of lithium secondary batteries including silicon oxycarbide prepared by pyrolyzing intermediates according to a comparative example and an example of the present invention as a negative electrode active material.

As shown in FIG. 9, it was confirmed that the silicon oxycarbide according to the present invention, which included many pores due to addition of a POSS, exhibited a maximum specific capacity of 980 mAh/g at a current density of 180 mA/g and maintained a specific capacity of 412 mAh/g even at a very high current density of 3600 mA/g, and thus remarkably excellent capacity characteristics were exhibited compared to the silicon oxycarbide of the comparative examples in which a POSS was not added.

In addition, as shown in FIG. 10, it was confirmed that the silicon oxycarbide according to the present invention, which included many pores due to addition of a POSS, maintained 94% of the initial specific capacity even after 200 cycles, and thus exhibited remarkably excellent cycle stability. As confirmed above, it can be seen that this is because the dispersibility of electrolyte ions is enhanced through pores formed by addition of a POSS.

However, in the case of the sample (SiOC—POSS 0.3 g) in which an excessive amount of POSS was added, it was confirmed that the capacity and cycle stability decreased again. This result is considered to be due to the fact that, when a POSS content is increased to 0.3 g, a certain amount or more of free carbon decreases, and thus a discontinuous free carbon site in the SiOC structure interferes with electron transfer, thereby leading to a decrease in electrochemical performance.

The embodiments disclosed in this specification and drawings are only examples to help with understanding of the present invention, and the present invention is not limited thereto. It is clear to those skilled in the art that various modifications based on the technological scope of the present invention in addition to the embodiments disclosed herein can be made.

1. An intermediate for preparing porous silicon oxycarbide, having a three-dimensional network structure and comprising:
linear polysiloxane polymer main chains;
a plurality of polyhedral oligomeric silsesquioxane (POSS) moieties disposed between the linear polysiloxane polymer main chains; and
a bond represented by the following Chemical Formula 1, which is formed between the linear polysiloxane polymer and the POSS moiety. 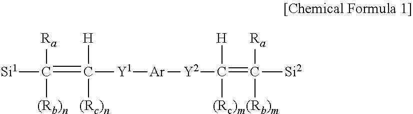
(In Chemical Formula 1,
Si¹ represents a linear polysiloxane polymer,
Si² represents a POSS moiety,
Rₐ, R_{b}, and R_{c} each independently represent a hydrogen atom or a C₁ to C₂₀ linear or branched alkyl,
Y¹ and Y² each independently represent a bond, —O—, —S—, or a C₁ to C₂₀ alkylene,
n and m are each independently 0 or 1,
when n=1 or m=1, bonds ( [symbol] ) between CRₐR_{b} and CR_{c}H are each independently a single bond,
when n=0 or m=0, bonds ( [symbol] ) between CRₐR_{b} and CR_{c}H are each independently a double bond, and
Ar represents a C₃ to C₂₀ arylene or heteroarylene, wherein the heteroarylene includes at least one of N, O, and S in the ring.)

2. The intermediate of claim 1, wherein the intermediate is in the form of an aerogel.

3. The intermediate of claim 1, wherein the polyhedral oligomeric silsesquioxane (POSS) moiety is any one or a combination of the following compounds (1) to (6). 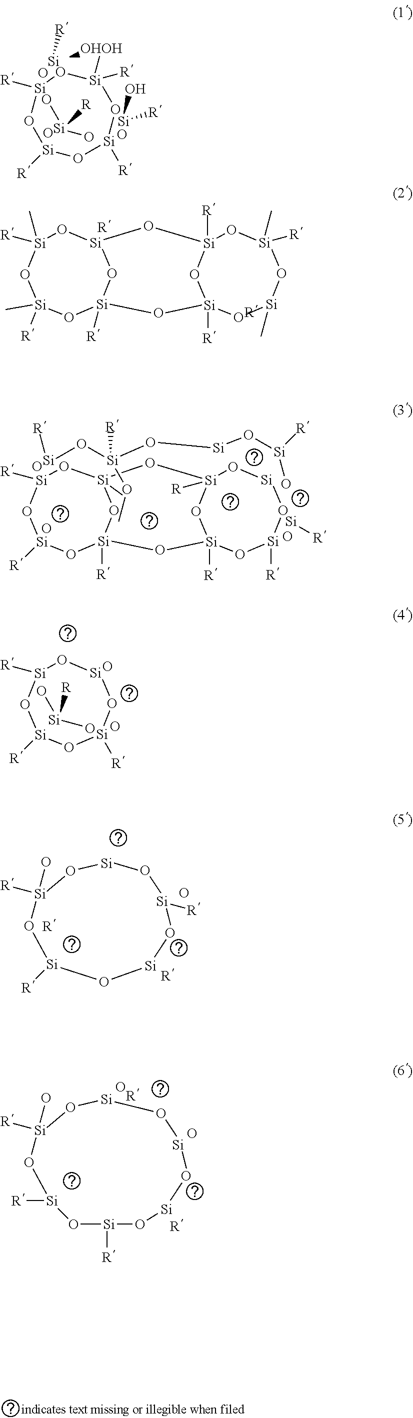
(In individual compounds (1) to (6), at least two Rs each independently represent —OSi²R^{A}R^{B}—*, wherein R^{A} and R^{B} represent any one of a hydrogen atom, a halogen atom, a hydroxy, and a C₁ to C₂₀ linear or branched alkyl, alkene, alkyne, or alkoxy, and
the remaining Rs each independently represent any one of a hydrogen atom, a halogen atom, a hydroxy, a C₁ to C₂₀ linear or branched alkyl, alkene, alkyne, or alkoxy, a C₅ to C₂₀ aryl, and —OSir¹r²r³, wherein r¹, r², and r³ each independently represent any one of a hydrogen atom, a halogen atom, a hydroxy, and a C₁ to C₂₀ linear or branched alkyl, alkene, alkyne, or alkoxy.)

4. The intermediate of claim 1, wherein the polyhedral oligomeric silsesquioxane (POSS) moiety has a cage structure.

5. The intermediate of claim 1, wherein the polyhedral oligomeric silsesquioxane (POSS) moiety is included in an amount of less than 3 parts by weight based on 100 parts by weight of the intermediate.

6. A method of preparing an intermediate for preparing porous silicon oxycarbide, the method comprising:
hydrosilylating a linear polysiloxane polymer, a polyhedral oligomeric silsesquioxane (POSS), and an aromatic compound, in which two or more functional groups including a vinyl group or an acetylene group at a terminal thereof are substituted, to form an organosilicon bond between the linear polysiloxane polymer and the aromatic compound and between the POSS and the aromatic compound.

7. The method of claim 6, wherein the linear polysiloxane polymer has a repeat unit represented by the following Chemical Formula 2. 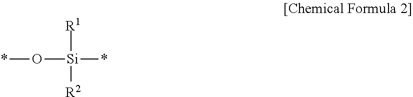
(In Chemical Formula 2,
R¹ and R² each independently represent a hydrogen atom or a C₁ to C₂₀ linear or branched alkyl, and
at least one of R¹ and R² represents a hydrogen atom.)

8. The method of claim 6, wherein the POSS is a compound represented by the following Chemical Formula 3.
(R′—SiO_{1.5})ₙ [Chemical Formula 3]
(In Chemical Formula 3,
n is 8 to 16, at least two of the 8 to 16 R′s represent —OSi²HR^{A}R^{B} involved in the hydrosilylation, wherein R^{A} and R^{B} represent any one of a hydrogen atom, a halogen atom, a hydroxy, and a C₁ to C₂₀ linear or branched alkyl, alkene, alkyne, or alkoxy, and
the remaining Rs each independently represent any one of a hydrogen atom, a halogen atom, a hydroxy, a C₁ to C₂₀ linear or branched alkyl, alkene, alkyne, or alkoxy, a C₅ to C₂₀ aryl, and —OSir¹r²r³, wherein r¹, r², and r³ each independently represent any one of a hydrogen atom, a halogen atom, a hydroxy, and a C₁ to C₂₀ linear or branched alkyl, alkene, alkyne, or alkoxy.)

9. The method of claim 6, wherein the organosilicon bond between the linear polysiloxane polymer and the aromatic compound and between the POSS and the aromatic compound is a bond represented by the following Chemical Formula 1. 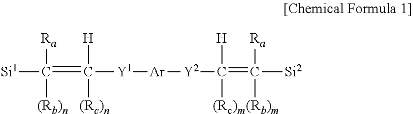
(In Chemical Formula 1,
Si¹ represents a linear polysiloxane polymer,
Si² represents a POSS,
Rₐ, R_{b}, and R_{c} each independently represent a hydrogen atom or a C₁ to C₂₀ linear or branched alkyl,
Y¹ and Y² each independently represent a bond, —O—, —S—, or a C₁ to C₂₀ alkylene,
n and m are each independently 0 or 1,
when n=1 or m=1, bonds ( [symbol] ) between CRₐR_{b} and CR_{c}H are each independently a single bond,
when n=0 or m=0, bonds ( [symbol] ) between CRₐR_{b} and CR_{c}H are each independently a double bond, and
Ar represents a C₃ to C₂₀ arylene or heteroarylene.)

10. The method of claim 6, wherein the polysiloxane polymer is selected from the group consisting of polymethylhydrosiloxane (PMHS), polyethylhydrosiloxane (PEHS), polydimethylsiloxane-co-methylphenylsiloxane (silicone oil), and polymethylphenylsiloxane (PMPS).

11. The method of claim 6, wherein the polysiloxane polymer has a weight-average molecular weight (Mw) of 400 to 10,000.

12. The method of claim 6, wherein the POSS is any one or a combination of the following compounds (1′) to (6′). 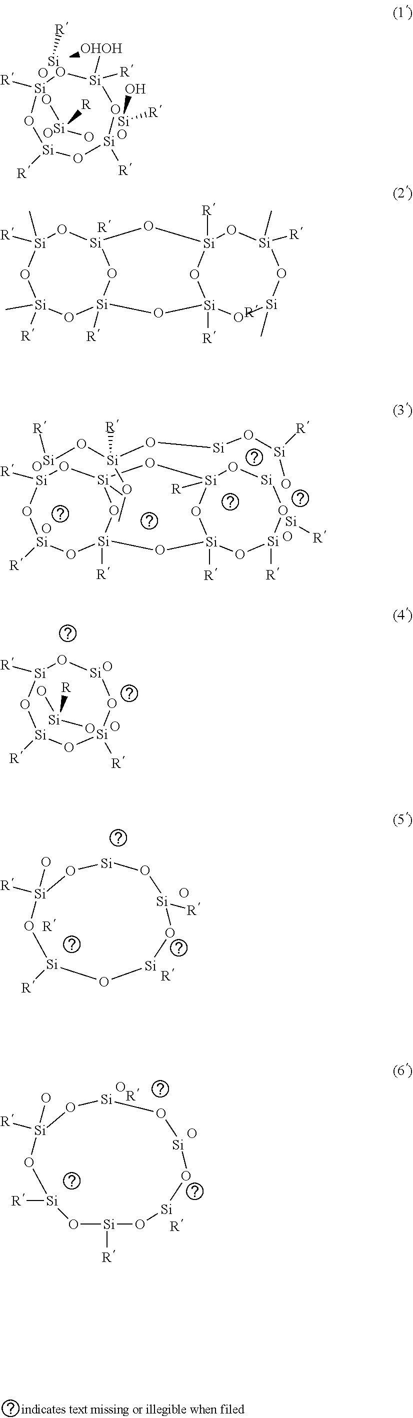
(in individual compounds (1) to (6), R′ is as defined in Chemical Formula 3.)

13. The method of claim 6, wherein the POSS has a cage structure.

14. The method of claim 6, wherein the aromatic compound is a compound represented by the following Chemical Formula 4. 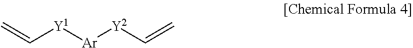
(In Chemical Formula 4,
Y¹ and Y² each independently represent a bond or a C₁ to C₂₀ alkylene, and
Ar is a C₃ to C₂₀ arylene or heteroarylene.)

15. The method of claim 6, wherein the aromatic compound is selected from the group consisting of divinylbenzene (DVB) and polystyrene (PS).

16. A method of preparing porous silicon oxycarbide, comprising:
hydrosilylating a linear polysiloxane polymer, a polyhedral oligomeric silsesquioxane (POSS), and an aromatic compound, in which two or more functional groups including a vinyl group or an acetylene group at a terminal thereof are substituted, to prepare an intermediate having an organosilicon bond between the linear polysiloxane polymer and the aromatic compound and between the POSS and the aromatic compound (first step); and
pyrolyzing the intermediate to prepare porous silicon oxycarbide (SiOC) (second step).

17. The method of claim 16, wherein a temperature of the pyrolysis is 800 to 1200° C.

18. Porous silicon oxycarbide prepared by the method of claim 16 and having a specific surface area of 5 to 10 m²/g and a pore volume of 0.01 to 0.05 cm³/g.

19. A lithium secondary battery comprising:
a negative electrode including the porous silicon oxycarbide prepared by the method of claim 16 as a negative electrode active material;
a positive electrode; and
an electrolyte interposed between the negative electrode and the positive electrode.
